(19) United States
(12) Patent Application Publication
(10) Pub. No.: US 2024/0167695 A1
(43) Pub. Date: May 23, 2024

(54) Configurable Apparatus and Method For Vertical Food Roasting

(71) Applicants: Philip Lien Slen, Calgary (CA); Rodney James Frans, Kanata (CA)

(72) Inventors: Philip Lien Slen, Calgary (CA); Rodney James Frans, Kanata (CA)

(21) Appl. No.: 18/540,867

(22) Filed: Dec. 15, 2023

(51) Int. Cl. F24C 15/16

(52) U.S. Cl. CPC F24C 15/164

(57) ABSTRACT

A configurable apparatus for vertical food roasting has a fixed centered anchor to support a removeable vertical pole or a removable vertical food skewer. Top section of vertical pole further supports interchangeable food hooks. When interchangeable food hooks are engaged, a variety of food items could be attached and cooked vertically above the surface of the configurable apparatus. Alternatively, when the removable vertical food skewer frame member is engaged, a removeable horizontal food grill could be installed onto the fixed centered anchor. Food items could be stacked in a vertical formation on the horizontal food grill and cooked in vertical fashion. High side wall of roasting apparatus catches all oil drips, and wide handles on either side of side wall allows for safe and stable movement and transfer of hot oil drips and roasted hot food items while they are engaged onto interchangeable food hook or vertical food skewer.

### BACKGROUND

The conventional approach to roasting various food items like chicken, duck, beef, pork, fish, other meats, and various skewered food items at home involves using the standard stove-oven. Typically, these food items are placed horizontally on a roasting rack, positioned over a roasting pan. However, this method presents two significant challenges.

First, it results in uneven cooking, as the top and bottom parts of the food items don't brown or crisp up uniformly. Even with the introduction of stove-oven convection technology, the lower portion of the food item, normally situated beneath or at the same level as the top of the roasting pan, fails to achieve the desired level of browning and crispiness due to the roasting pan obstructing the convection heat airflow. This necessitates manual food rotation, which can be risky in a hot oven. Removing the roasting pan from the oven to rotate the food is both impractical and unsafe, especially when dealing with larger food items like whole poultry.

Second, attempt to elevate food items to a more upright position for more even heat cooking poses its own set of problems. There is no reliable and easy-to-use vertical support apparatus to securely hold and anchor the food items to the roasting pan. The high center of gravity of unsecured vertically positioned food items presents safety concerns when handling scalding-hot food, as the risk of food items tipping over is a major hazard for personal injuries and burns.

The solution lies in creating a secured and robust vertical food positioned roasting pan, which permits the stove-oven's convection heat to surround the entire food item for uniform cooking. The innovation of a configurable vertical food-positioned roasting pan apparatus, equipped with interchangeable food item hooks, effectively tackles these issues. With this apparatus, a variety of food items can now achieve uniform cooking, browning and crispiness without the need for manual intervention during the cooking process. This inventive approach offers a safer, more practical, and efficient alternative to traditional roasting methods.

### BRIEF DESCRIPTION OF THE DRAWINGS

FIGS. 1A and 1B are perspective views of the first embodiment of the configurable apparatus for vertical food roasting of the invention configured with two first-interchangeable food hook frame member FIGS. 5D, engaged respectively;

FIG. 1C is the exploded perspective view of FIGS. 1A and 1B;

FIGS. 1D and 1E are perspective views of FIGS. 1A and 1B with a whole poultry food item hooked there onto each individual first-interchangeable food hook frame member FIGS. 5D, respectively;

FIG. 2A is a perspective view of the second embodiment of the configurable apparatus for vertical food roasting of the invention configured with two second-interchangeable food hook frame member FIG. 5G;

FIG. 2B is the exploded perspective view of FIG. 2A;

FIG. 2C is a perspective view of FIG. 2A with strips of meat food item hooked there onto each individual second-interchangeable food hook frame member FIGS. 5G, respectively;

FIG. 3A is a perspective view of an alternate configuration of the first and second embodiments of the configurable apparatus for vertical food roasting of the invention configured with the first-interchangeable food hook frame members FIG. 5D and the second-interchangeable food hook frame member FIGS. 5G, respectively;

FIG. 3B is the exploded perspective view of FIG. 3A;

FIG. 3C is a perspective view of FIG. 3A with a whole poultry food item hooked there onto the first-interchangeable food hook frame member FIG. 5D and with strips of meat food item hooked there onto the second-interchangeable food hook frame member FIG. 5G;

FIG. 4A is a perspective view of the third embodiment of the configurable apparatus for vertical food roasting of the invention configured with the third-interchangeable food hook frame member FIGS. 5J and 5K, engaged respectively;

FIG. 4B is the exploded perspective view of FIG. 4A;

FIG. 4C is an elevation view of FIG. 4B;

FIG. 4D is a perspective view of FIG. 4A with stack of meat food item hooked there onto the third-interchangeable food hook frame member FIG. 5J and FIG. 5K;

FIG. 5A is a perspective view of the configurable apparatus for vertical food roasting pan;

FIG. 5B is an enlarged perspective view of the fixed centered anchor hitch receiver frame member;

FIG. 5C is a perspective view of the removeable vertical pole frame member;

FIG. 5D is a perspective view of the first-interchangeable food hook frame member;

FIG. 5E in an enlarged perspective view of FIG. 5D;

FIG. 5F is a perspective view of the first-interchangeable food hook frame member FIG. 5D inserted into the removeable vertical pole frame member FIG. 5C;

FIG. 5G is a perspective view of the second-interchangeable food hook frame member;

FIG. 5H is an enlarged perspective view of FIG. 5G;

FIG. 5I is a perspective view of the food S hook frame member;

FIG. 5J is a perspective view of the removeable horizontal food grill frame member;

FIG. 5K is a perspective view of the removeable vertical food skewer frame member.

### DETAILED DESCRIPTION OF EMBODIMENTS

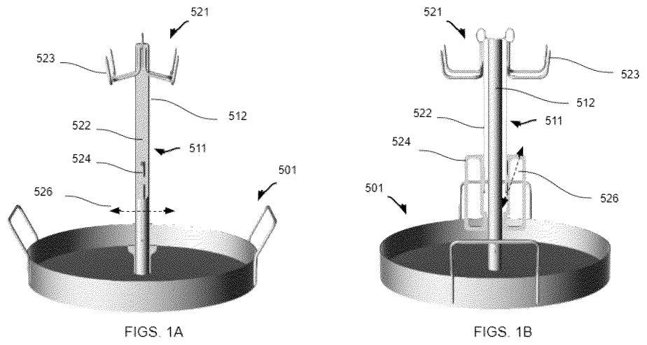

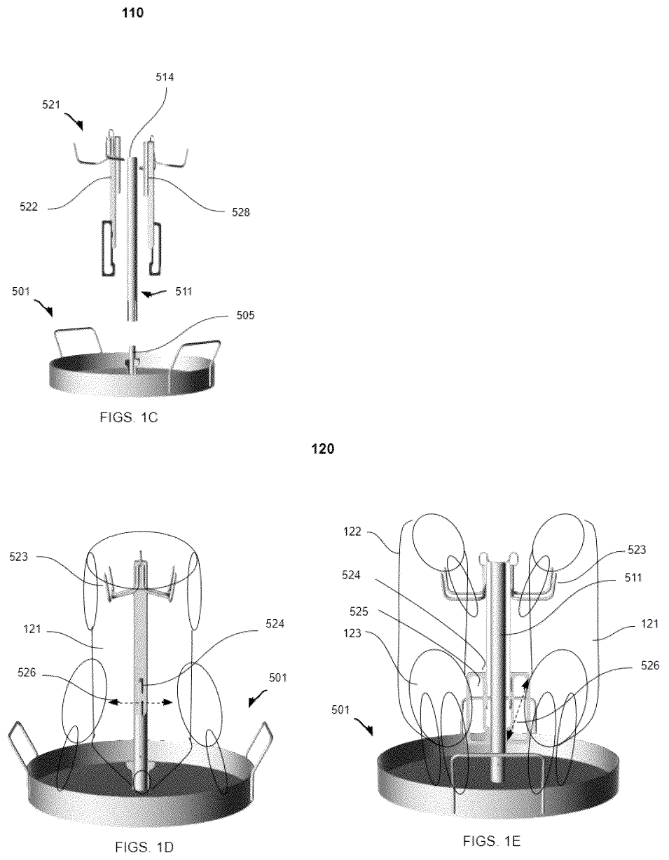

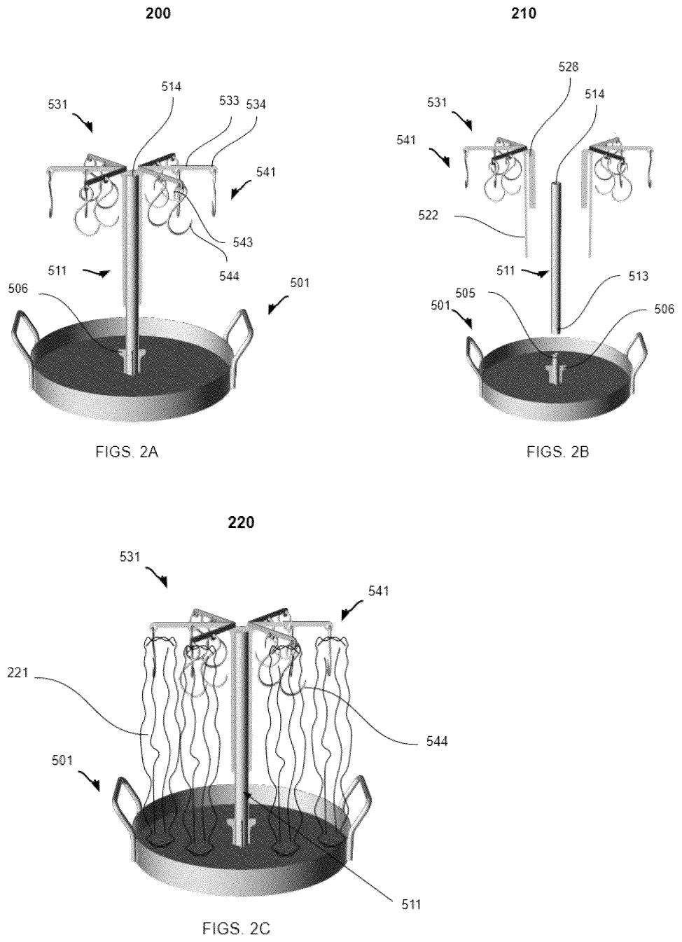

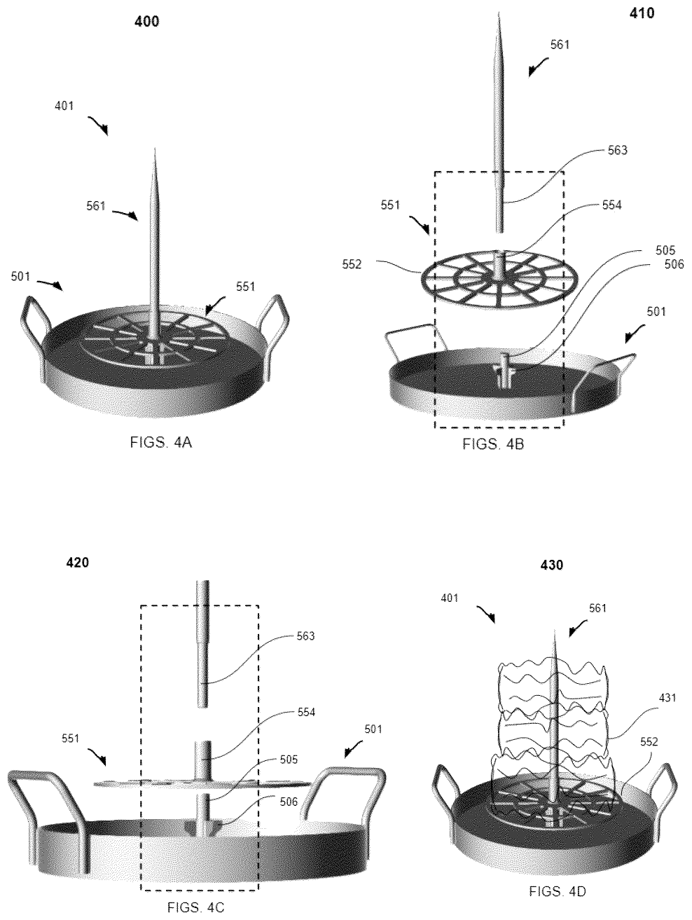

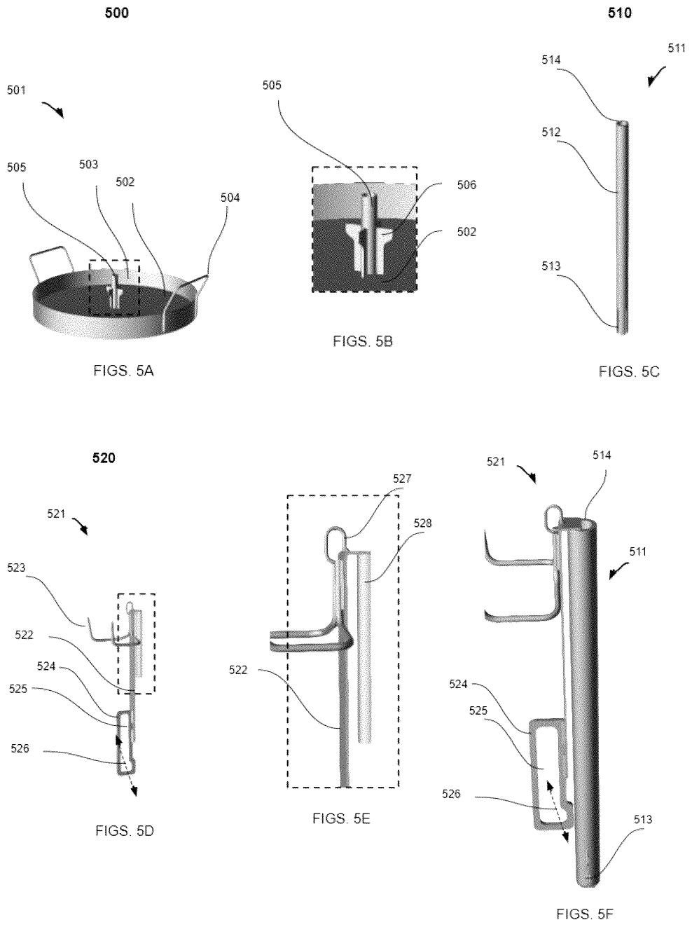

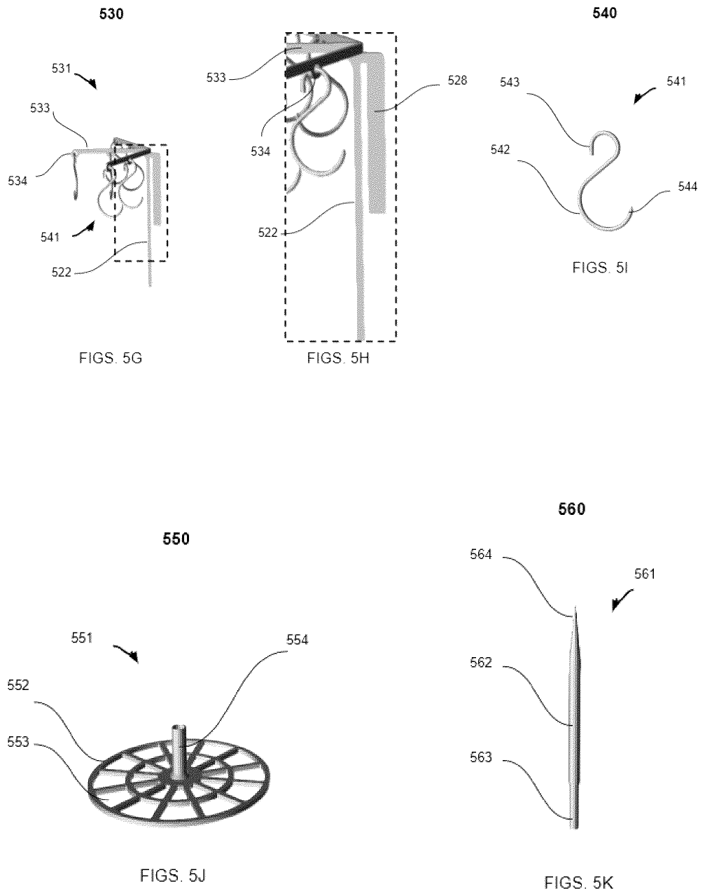

The three embodiments of the configurable apparatus for vertical food roasting of the invention are illustrated in general at 100 in FIGS. 1A and 1B, at 200 in FIG. 2A and at 400 in FIGS. 4A, respectively. The main components for these three embodiments are illustrated at 500 in FIGS. 5A and 5B, at 510 in FIGS. 5C, at 520 in FIGS. 5D, 5E and 5F, at 530 in FIGS. 5G and 5H, at 540 in FIG. 5I, at 550 in FIG. 5J, and at 560 in FIG. 5K. The following paragraphs breaksdown each embodiment in greater details.

Important note: the concept of an anchor providing a sturdy support to the removable and interchangeable components of the configurable apparatus for vertical food roasting are described analogously to the concept of a hitch receiver and a hitch, respectively. Their connection together would cajole a person skilled in the art to apply this similar concept to the functional embodiment of the hitch being the removeable and interchangeable components fitting into the hitch receiver being the anchor that supports the hitch.

The materials to manufacture the configurable apparatus for vertical food roasting could be a food contact safe, high temperature metal such as coated carbon steel or stainless steel. A person skilled in the art would be able to determine the appropriate material to use.

The first embodiment of the configurable apparatus for vertical food roasting invention at 100 in FIGS. 1A and 1B and its components at 500 in FIGS. 5A and 5B, at 510 in FIGS. 5C, at 520 in FIGS. 5D, 5E, and 5F. At 500 in FIGS. 5A, the configurable apparatus for vertical food roasting pan 501 has the pan base frame member 502 and pan wall frame member 503 welded-on together. Pan handles frame member 504 welded-on the outside of pan wall frame member 503 opposite one another. The fixed centered anchor hitch receiver frame member 505 is welded-on pan base frame member 502 and reinforced with welded-on hitch receiver clipped delta fins support frame member 506 as illustrated in enlarged view FIG. 5B. At 510 in FIGS. 5C, the removeable vertical pole frame member 511 comprises a hollow shaft 512 illustrated with bottom end perpendicular lateral slits 513 and top opening hitch receiver 514.

At 520 in FIGS. 5D, an embodiment of a food hook is illustrated in the first-interchangeable food hook frame member 521. It comprises of food hooks frame member 523 welded-on to the top end of a shaft frame member 522. An air-gap frame member 524 is welded-on to the bottom end of the shaft frame member 522. The air-gap 525 ensures air movement and air flow 526 goes through it during the cooking process. Enlarged view FIG. 5E illustrates shaft frame member 522 with a top ring frame member 527 and the hanger hitch frame member 528. FIG. 5F further illustrates the first-interchangeable food hook frame member 521 with its hanger hitch frame member 528 inserted into the top opening hitch receiver 514 of the removeable vertical pole frame member 511. In this embodiment of a food hook in FIG. 5F with the bottom end perpendicular lateral slits 513 are inserted onto the fixed centered anchor hitch receiver frame member 505 into the hitch receiver clipped delta fins support frame member 506 in FIG. 5A. Lastly, insert a second first-interchangeable food hook frame member 521 back-to-back to the first one as in FIGS. 5F, into the removeable vertical pole frame member 511 described above. This completes the assembly of the first embodiment of the configurable apparatus for vertical food roasting invention at 100 in FIGS. 1A and 1B.

At 110 in FIGS. 1C, is an exploded perspective view of the first embodiment of the configurable apparatus for vertical food roasting FIGS. 1A and 1B. Example of a use case for the first embodiment of the configurable apparatus for vertical food roasting invention is at 120 in FIGS. 1D and 1E. FIG. 1D is a front perspective view of the configurable apparatus for vertical food roasting pan 501 with the embodiment of a food hook in FIG. 5F inserted into the fixed centered anchor hitch receiver frame member 505. A whole poultry food item 121 is hooked onto the food hooks frame member 523. FIG. 1E is a side perspective view that further illustrates the whole poultry food item 121 positioned with its breast side 122 at the top facing outward and the food hooks frame member 523 are inserted into the backside of the whole poultry food item. The whole poultry drum legs 123 are dangling above the configurable apparatus for vertical food roasting pan 501. The air-gap frame member 524 prevents the whole poultry drum legs 123 section from swinging backwards into contact with the removeable vertical pole frame member 511 which would have reduced convection air-flow 526 during cooking process.

The second embodiment of the configurable apparatus for vertical food roasting invention at 200 in FIG. 2A and its components at 530 in FIGS. 5G and 5H, and at 540 in FIG. 5I. At 530 in FIG. 5G, an alternate embodiment of a food hook is illustrated in the second-interchangeable food hook frame member 531. It comprises of multiple-arms hanger frame member 533 welded-on to the top end of the shaft frame member 522. Each arm hanger has two aperture hitch receiver frame member 534. Enlarged view FIG. 5H illustrates the shaft frame member 522 with the multiple-arms hanger frame member 533 and the hanger hitch frame member 528. In this second-interchangeable food hook frame member 531 embodiment, the aperture hitch receiver frame member 528 acts as an anchor for alternative food hook frame member. One example of this alternative food hook is the S hook food hook frame member 541 as illustruction in FIG. 5I. The S hook hitch frame member 543 would be inserted through the aperture hitch receiver frame member 534. Opposite end of the S hook shaft frame member 542 is the S hook food skewer tip 544.

At 210 in FIG. 2B is the exploded view of the second embodiment of the configurable apparatus for vertical food roasting invention at 200 in FIG. 2A. The configurable apparatus for vertical food roasting pan 501 with the removeable vertical pole frame member 511 where bottom end perpendicular lateral slits 513 are inserted onto the fixed centered anchor hitch receiver frame member 505 into the hitch receiver clipped delta fins support frame member 506. The hanger hitch frame member 528 is inserted into the top opening hitch receiver 514. Example of a use case for the second embodiment of the configurable apparatus for vertical food roasting invention is at 220 in FIG. 2C. FIG. 2C illustrates strips of meat food item 221 hooked by S hook food skewer tip 544.

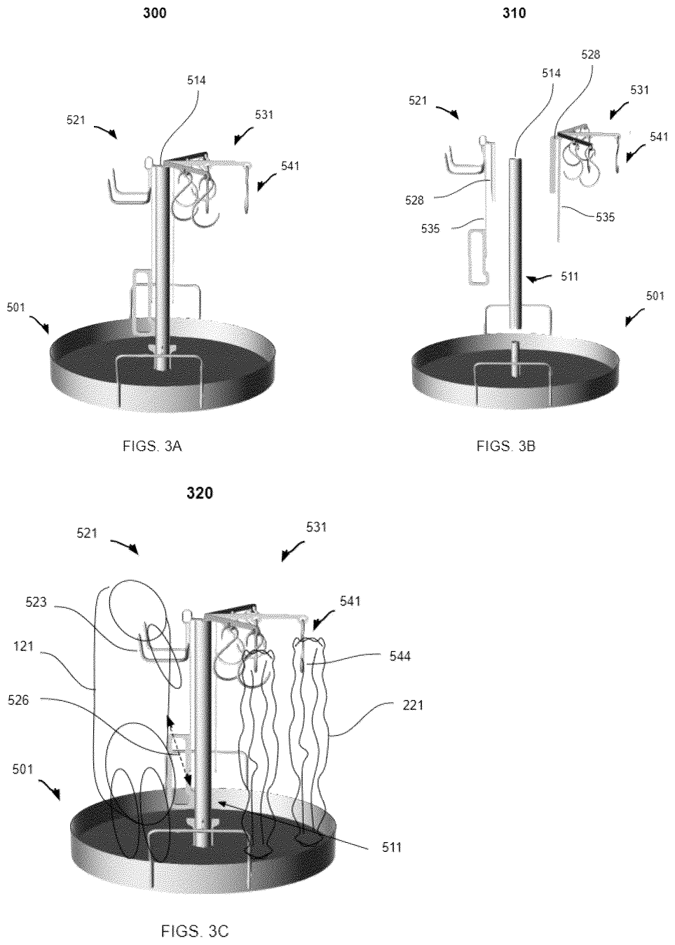

An alternate configuration of the first and second embodiments of the configurable apparatus for vertical food roasting of the invention is illustrated at 300 in FIG. 3A. At 310 in FIG. 3B is the exploded view of FIG. 3A. Both the first-interchangeable food hook frame members 521 and the second-interchangeable food hook frame member 531 are inserted into the top opening hitch receiver 514 to create an alternate use case. At 320 in FIGS. 3C, a whole poultry food item 121 inserted into the food hooks frame member 523 on the first-interchangeable food hook frame members 521 and strips of meat food item 221 are hooked on by S hook food skewer tip 544 on the second-interchangeable food hook frame member 531. This is one example of the plurality of food hook configurations the configurable apparatus for vertical food roasting of the invention could accommodate. When the removeable vertical pole frame member 511 in FIG. 5C is inserted onto the fixed centered anchor hitch receiver frame member 505 into the hitch receiver clipped delta fins support frame member 506 in FIGS. 5A, the configurable apparatus for vertical food roasting pan 501 offers a stable roasting platform for plurality of interchangeable food hook frame members.

The third embodiment of the configurable apparatus for vertical food roasting 401 invention at 400 in FIG. 4A and its components at 550 in FIG. 5J and at 560 in FIG. 5K. At 550 in FIG. 5J is a removable horizontal food grill frame member 551. This frame member is comprised of a round grill frame member 552 with meshed air-gap 553 and at its center is a welded-on round grill hitch frame member 554. At 560 in FIG. 5K is the removeable vertical food skewer frame member 561 which is comprised of a solid skewer shaft frame member 562, where at the bottom is a tapered skewer hitch frame member 563 and at top the skewer tip 564.

At 410 in FIG. 4B is the exploded view of the third embodiment of the configurable apparatus for vertical food roasting 401 invention at 400 in FIG. 4A. FIG. 4B illustrates an example of the order of components assembly with the removable horizontal food grill frame member 551 and round grill hitch frame member 554 inserted into the fixed centered anchor hitch receiver frame member 505 and rests atop of the hitch receiver clipped delta fins support frame member 506. Then the removeable vertical food skewer frame member 561 with the tapered skewer hitch frame member 563 is inserted through the round grill hitch frame member 554 into the fixed centered anchor hitch receiver frame member 505. At 420 in FIG. 4C is an exploded elevation view of FIG. 4B. At 430 in FIG. 4D is an example of a food item 431 stacked in layers on top the round grill frame member 552 and skewered through by the removeable vertical food skewer frame member 561.

What is claimed:

1. A configurable apparatus for vertical food roasting comprising:
a. a roasting pan adapted to be the main cooking apparatus, said pan has a fixed centered anchor frame member;
b. a removable vertical pole support frame member;
c. a removable and interchangeable food hooks frame member;
d. a removable vertical skewer frame member; and
e. a removable horizontal food grill frame member.

2. The apparatus of claim 1 wherein the fixed centered anchor frame member is a welded-on short, vertical, hollow tube reinforced with clipped delta fins frame member.

3. The apparatus of claim 2 wherein the fixed centered anchor frame member provides sturdy support to plurality of vertical food roasting hooks frame members.

4. The apparatus of claim 1 wherein the removable vertical pole support frame member is a straight long hollow tube with perpendicular lateral slits at the hollow bottom end.

5. The apparatus of claim 4 wherein the removable vertical pole support frame member is a straight long hollow tube with opened top end.

6. The apparatus of claim 5 wherein the vertical pole support frame member opened top end supports a plurality of interchangeable food hooks frame members.

7. The apparatus of claim 6 wherein food hooks frame members are welded-on to the top shaft of the interchangeable food hooks frame members.

8. The apparatus of claim 6 wherein an air-gap spacer frame member is welded-on to bottom shaft.

9. The apparatus of claim 1 wherein the removable vertical skewer frame member is a straight long solid rod tapered at the bottom end.

10. The apparatus of claim 9 wherein the removable vertical skewer frame member is a straight long solid rod with skewer tip at the top end.

11. The apparatus of claim 1 wherein the removable horizontal grill frame member is a round meshed frame grill with a welded-on vertical short hollow tube at the center.

12. The apparatus of claim 9 wherein the straight long solid rod provides an anchor to a plurality of removable horizontal grill frame member.

13. A method for vertical food roasting using a cooking apparatus comprising the steps of:
a. providing a roasting pan with fixed centered anchor;
b. having an anchored vertical pole support frame member with food hooks; and
c. food hooks hang multiple food items over the roasting pan surface.

14. The method of claim 13 wherein the cooking device is an oven.
